(19) United States
(12) Patent Application Publication
(10) Pub. No.: US 2011/0036085 A1
(43) Pub. Date: Feb. 17, 2011

(54) APPARATUS FOR WAVE POWER GENERATION

(76) Inventor: Hans Oigarden, Oslo (NO)

Correspondence Address: WINSTEAD PC, P.O. BOX 50784, DALLAS, TX, 75201, US

(21) Appl. No.: 12/808,460

(22) PCT Filed: Dec. 19, 2008
(86) PCT No.: PCT/NO2008/000462

§ 371 Date: Oct. 28, 2010

(30) Foreign Application Priority Data
Dec. 19, 2007 (NO) 2007 6560

(51) Int. Cl. F03B 13/18

(52) U.S. Cl. 60/505

(57) ABSTRACT

Apparatus for generation of wave power comprising a first longitudinal floatation body (1) which is floating in a substantially vertical position in a body of water. The device also comprises a second floatation body (2), which encircles the first body (1) and the second body being adapted to move in response to waves relative to the first body (1). It also comprises energy transmission means (5, 6; 52, 53) coupled between the first and the second body, to transfer movement energy from the second body to at least one electric generator (8) on the first body. The first body (1) is anchored to the seabed by a tension leg (16), which is under a sufficient tension to prevent the first body (1) to move vertically because of the waves. The first body has a ballast chamber (29, 30), which is situated below the lowest level of the water.

The present invention relates to a device for generation of wave power according to the preamble of the subsequent claim 1.

Over the last years many attempts have been made to develop devices for generation of wave energy. The challenges for such devices are many and can be summarised as follows:
To develop a device which, when all costs (production, maintenance and operation) are included, can produce energy at a competitive price. This means that the device must be simple and cheap.
To achieve sufficient operating reliability. Very variable weather conditions at sea lead to the device being subjected to much stress. The device must be able to withstand at least one twenty-year storm without significant damage occurring.
To be able to deliver energy with considerable regularity. This means that the device must be able to deliver energy from both small and large waves over a wide spectrum of amplitudes and frequencies.

A principle for generation of wave power is known from EP 1295031. This relates to two bodies being set up to move in relation to each other. In this case, a central floating body is encircled by a ring-formed floating body. Each of the bodies is connected via a rod to submerged bodies which are set up to catch partly sea water and partly air. Thereby, the submerged bodies constitute a virtual mass. By adapting the virtual mass, one aims to get the two floating bodies to swing in different phases and thereby move in relation to each other.

It has been shown to be difficult to get the two bodies to swing in counter-phase and thereby achieve sufficient energy yield. The wave frequency varies over time and this means that the two bodies will, in many cases, swing more or less in the same phase.

To get the two bodies to swing in counter-phase the largest body must be at least twice as heavy as the smallest. If, in this way, one succeeds in getting the two bodies to swing in counter-phase, one will still not be able to achieve larger energy yield than what the smallest body is capable of producing. Therefore, the energy yield is very limited in such a system where the two bodies swing relatively freely in relation to each other. Furthermore, the known device is very complicated to produce, something which increases costs per kilowatt.

The ES 2193821 device of two buoys, one central buoy which is anchored to the ocean bed and a ring-formed buoy which floats and is connected to the central buoy via a remote transmission.

The central buoy is anchored to the ocean bed to limit its movements. The movements of the central buoy are thereby slow in relation to the ring buoy. This means that the central buoy will partly move together with, and partly move in counter-phase with, the ring buoy. Furthermore, the movement of the central buoy will vary with varying tides. At low ebb, it will move more with the waves than at high tides. The more the central buoy moves, the lower the efficiency of the power installation will be. In addition, in strong currents the buoy is pulled sideways in relation to its anchorage point on the ocean bed. Thereby, the central buoy will be lying somewhat lopsided in the water, which the ring buoy will thereby also do. In addition to such a lopsided position in the water in itself leading to further reduced efficiency, the friction between the ring buoy and the central buoy will also increase.

The fact that the central buoy is hermetically sealed against entry of water means that it will float as a cork and very small sideways forces are required before the central buoy comes into a considerably lopsided position.

A wave energy generation device which comprises a column that penetrates the ocean bed is known from U.S. Pat. No. 5,986,349. A cylinder is placed on top of the column and a floating ring is arranged around it. The floating ring is divided into four segments that move independently of each other. However, the segments are connected to each other by flanges.

The cylinder can move vertically on rails in relation to the column. The segments of the floating ring are connected to the cylinder via hinges and can move in relation to the cylinder. The wave energy is taken up by hydraulic actuators that extend between the segments of the floating ring and the cylinder.

Also described is a wave amplifier which is fastened at the bottom of the cylinder via a connection. The wave amplifier comprises two plates that are fastened to the cylinder in such a way that it is possible to adjust the vertical angle. The wave amplifier shall increase the amplitude of the waves so that the segments of the ring are lifted more than they otherwise would have been.

As the cylinder is arranged to move on the column, it will move with the waves and the energy yield due to the relative movement between the segments of the ring and the actuators will be minimal.

If the cylinder is kept still, the energy yield will still be small as the segments of the ring do not have a particularly long travel path in relation to the cylinder.

As the cylinder is arranged on a fixed column it is not necessary to equip it with a ballast chamber.

The installation of the fixed column will be both expensive and labour intensive. It must be both strong and have a strong anchorage to the ocean bed (i.e. a good depth of penetration).

WO 2006/113855 describes a floating cylinder with a surrounding floating ring. The cylinder is loosely anchored to the ocean bottom, which means that it will experience the same problems which were pointed out in connection with ES 2193821.

WO 01/73289 describes a wave energy generation device which comprises a central cylinder that is encircled by a ring-formed floating body. Two hydraulic actuators generate the energy. The central cylinder is fitted with a buoyancy chamber and a unit at the lower end which is described as a chamber. This chamber can contain water and thereby functions as ballast. The anchoring of the wave power installation is slack. The power installation will therefore experience the same problems as ES 2193821.

Thus, the present invention has as an aim of providing a device of the type described initially, that will have approximately the same efficiency independent of the wave conditions, i.e. wave frequency, wave amplitude and wave form.

The device according to the invention also has as an aim to be able to function with approximately the same efficiency independent of the tide level.

The device according to the invention also aims to be simple in its construction and relatively cheap to produce and operate.

The device according to the invention also has an aim to be robust so that it can withstand bad weather without suffering damage.

These and other aims are achieved according to the present invention in that the central floating body is anchored to the ocean bed via one or more tension legs such that it is not permitted to move vertically as a consequence of the effects of the waves.

Advantageous embodiments of the invention can be seen in the dependent claims.

The invention shall now be described in more detail with reference to the enclosed figures, where:

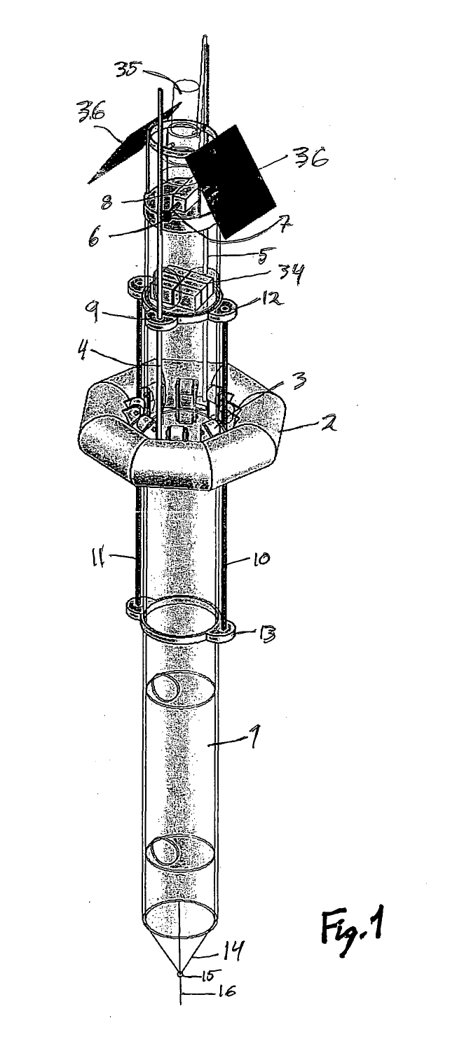

FIG. 1 shows a wave energy generation device according to the present invention.

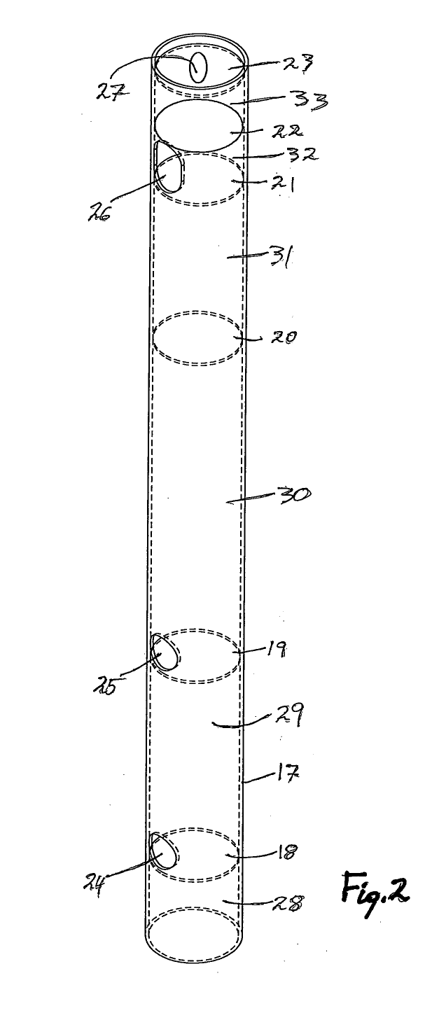

FIG. 2 shows the central floating body of the device in FIG. 1.

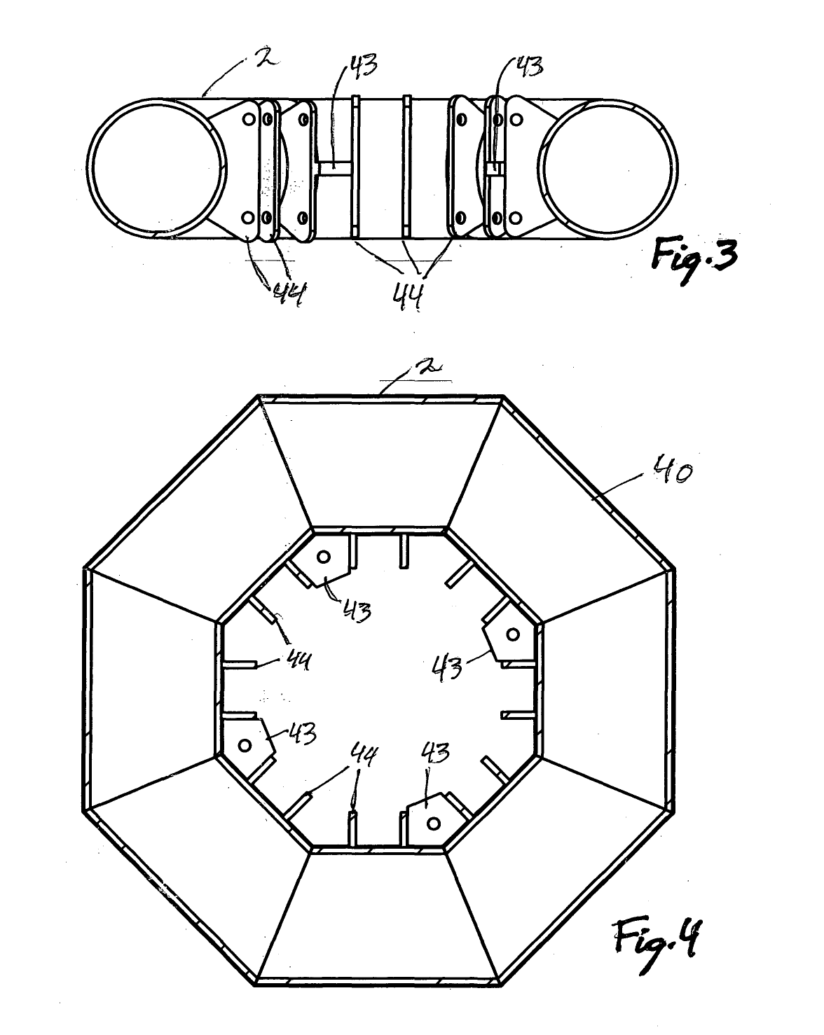

FIG. 3 shows a vertical section through the ring-formed body in FIG. 1.

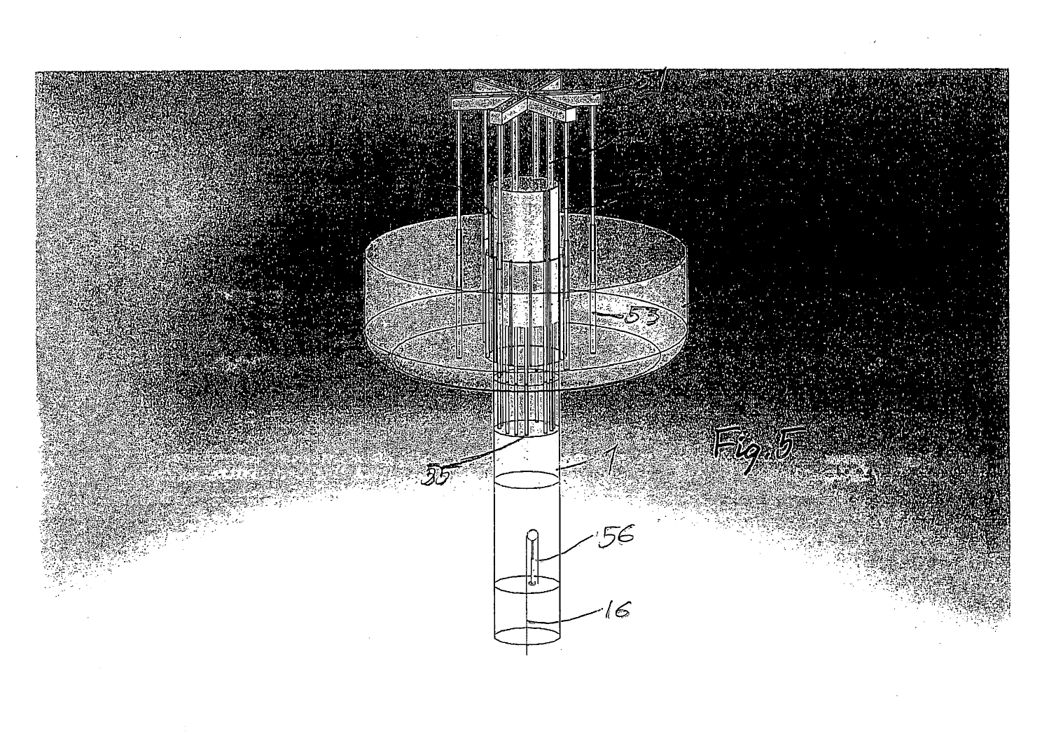

FIG. 4 shows a horizontal section through the ring-formed body in FIG. 1.

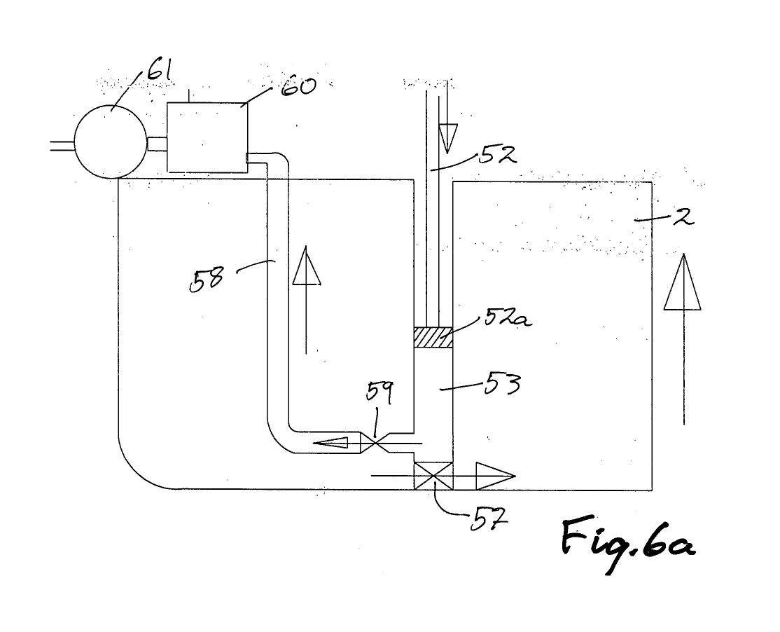

FIG. 5 shows a first alternative embodiment of the wave energy generation device according to the present invention.

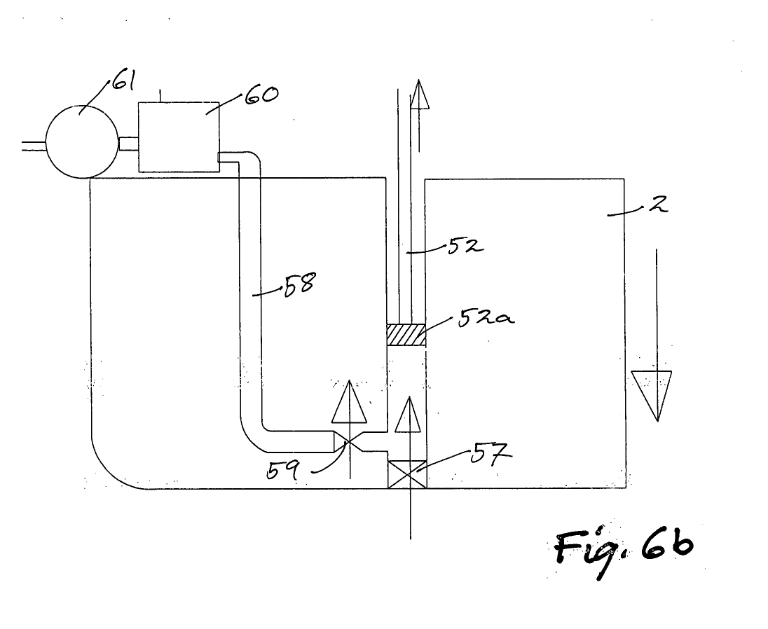

FIGS. 6a and 6b show in principle how a system for reverse osmosis can be included in the device according to the invention.

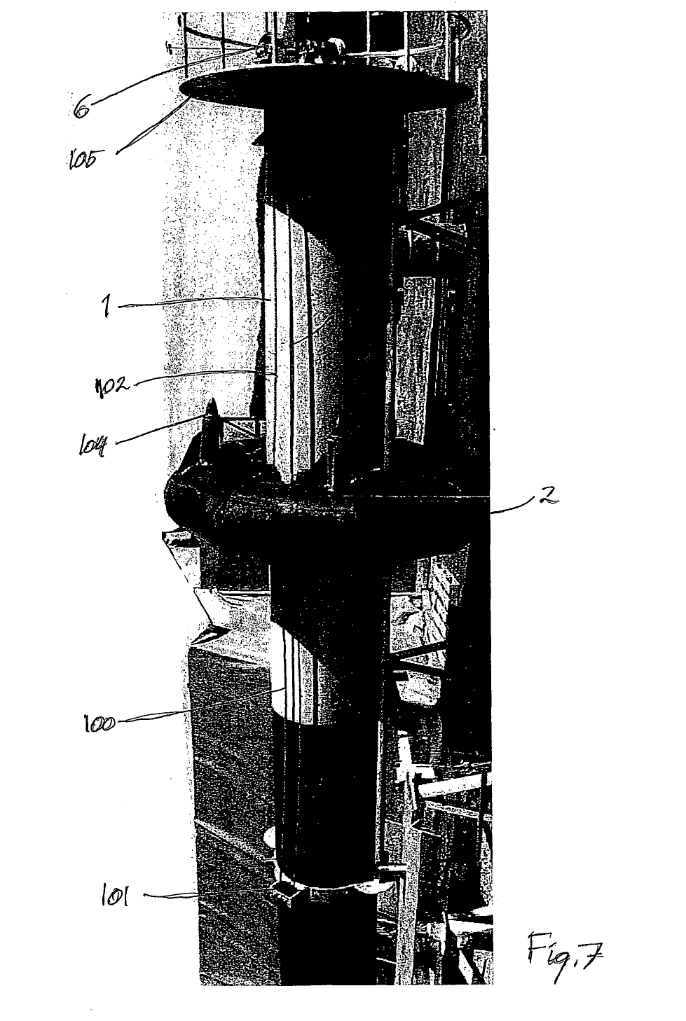

FIG. 7 shows a second embodiment of the wave energy generation device according to the present invention where a chain is used for transmission of the forces from the ring-formed body.

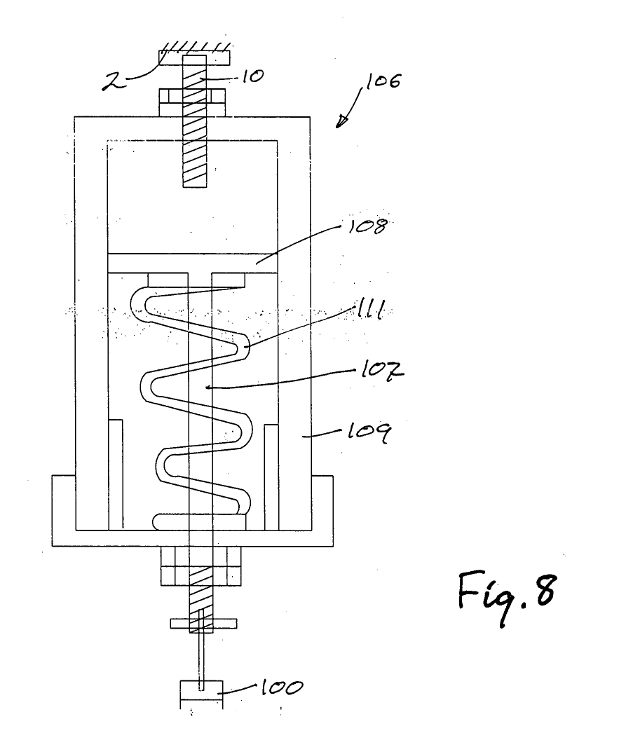

FIG. 8 shows a device for compensation of expansion of the central body from heat in a first mechanical embodiment.

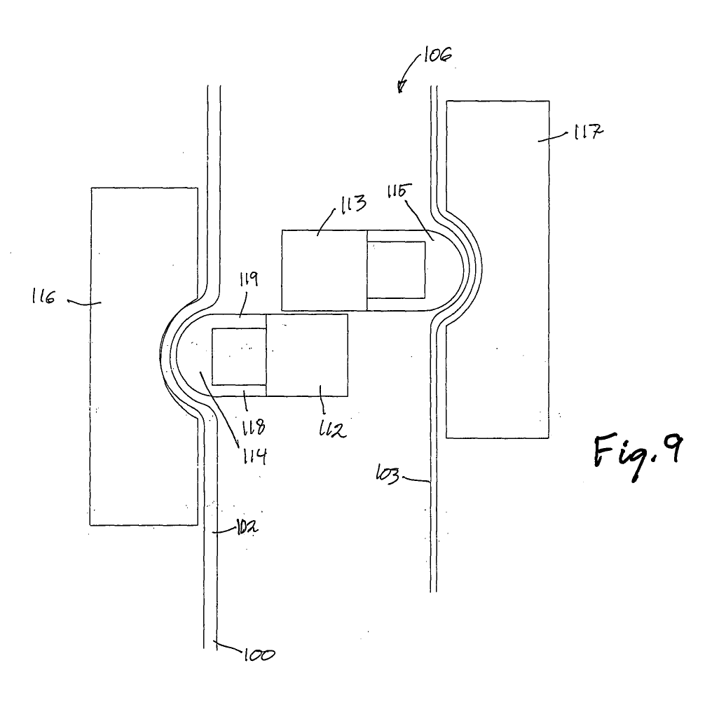

FIG. 9 shows a device for compensation of expansion of the central body from heat in a second embodiment.

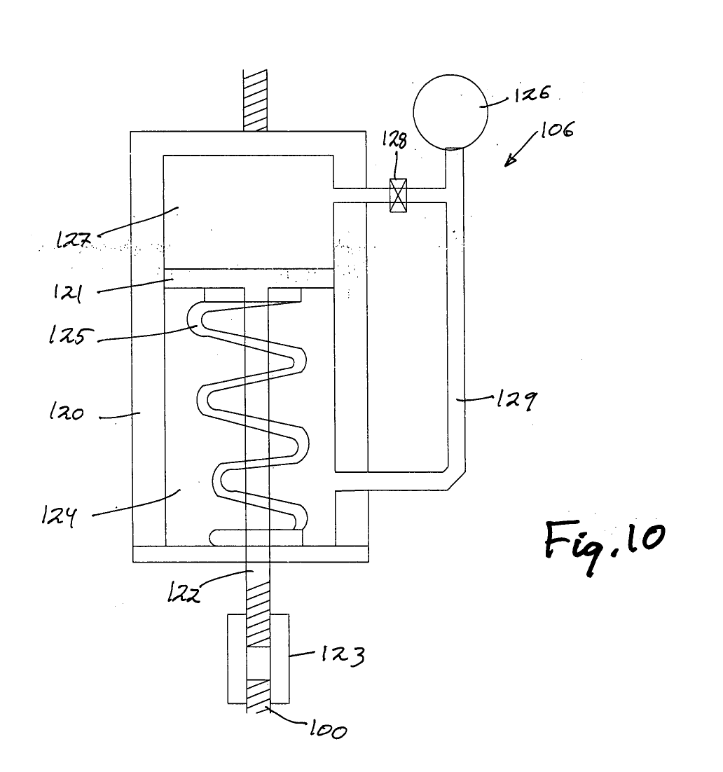

FIG. 10 shows a device for compensation of expansion of the central body from heat in a hydraulic embodiment.

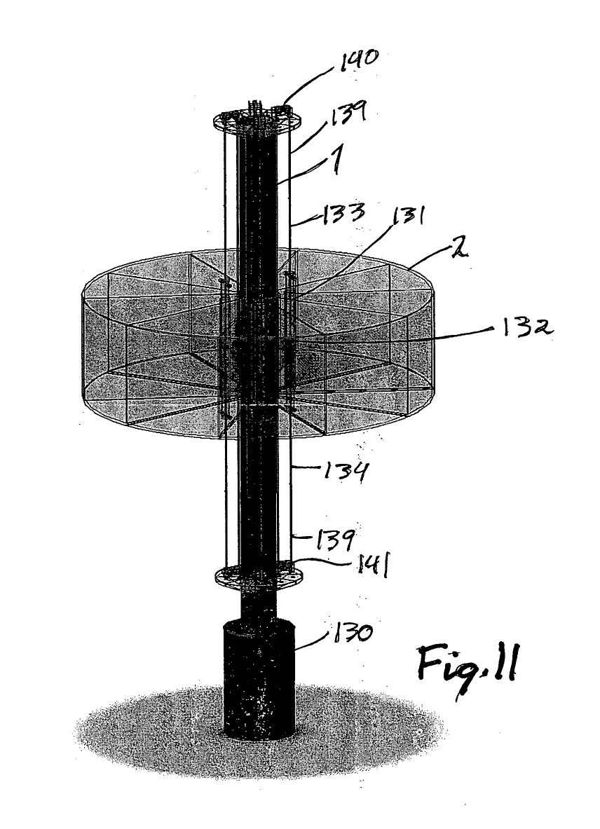

FIG. 11 shows a third alternative embodiment of the present invention where double-acting cylinders are used to bring out the energy.

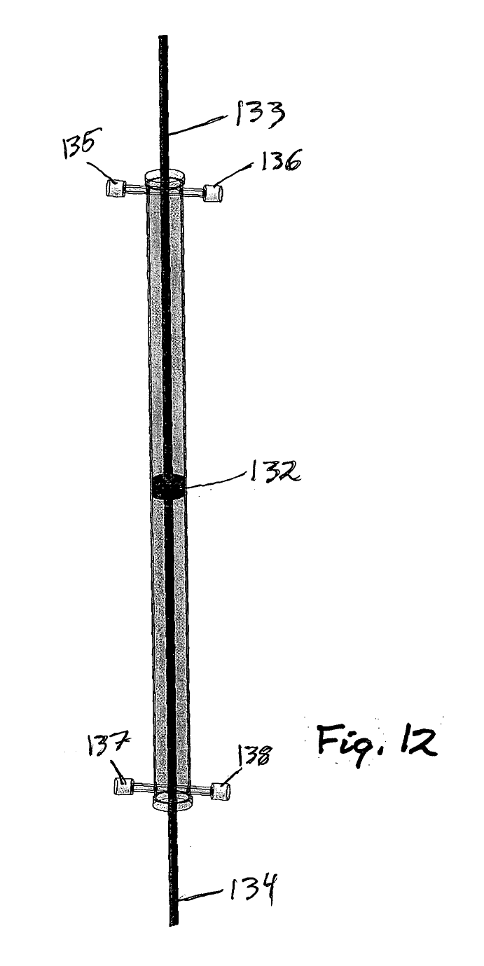

FIG. 12 shows one of the double-acting cylinders in detail.

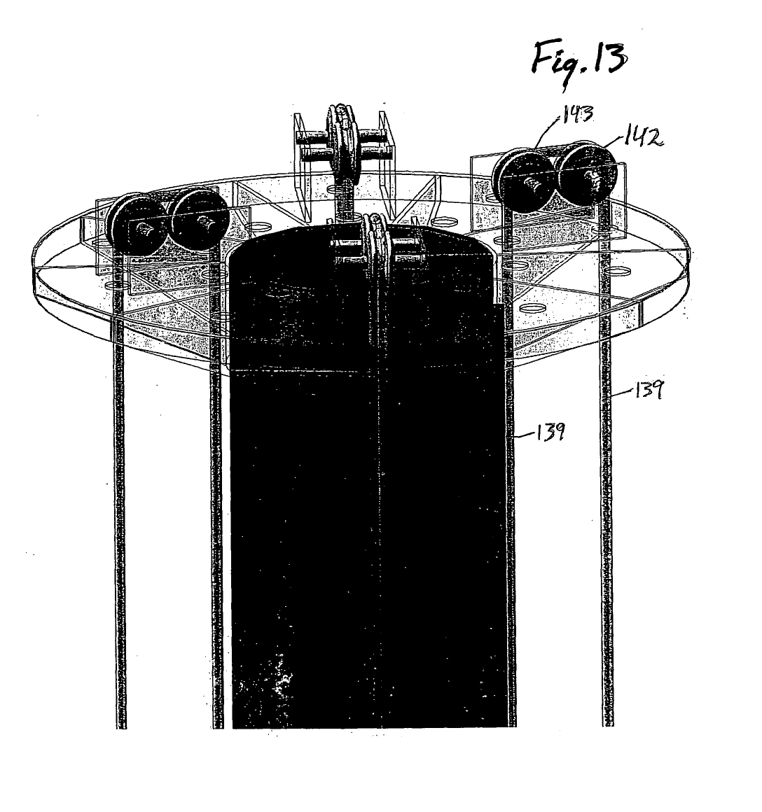

FIG. 13 shows the turning wheels on the top of the wave power installation in detail.

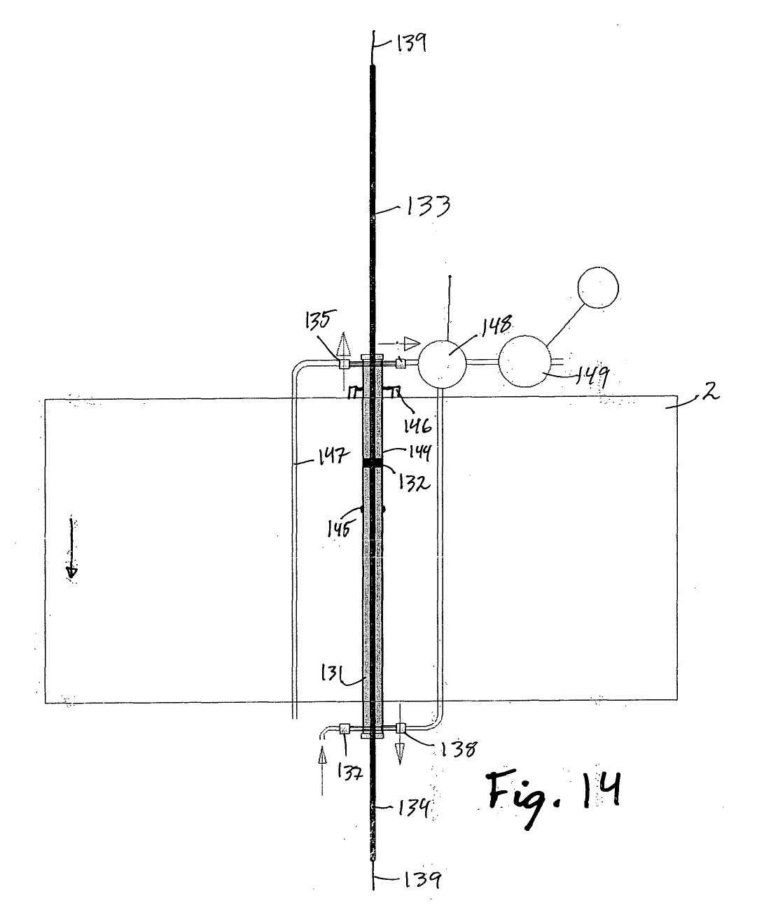

FIG. 14 shows the working mode of the hydraulic energy generation system when the floating body moves downwards.

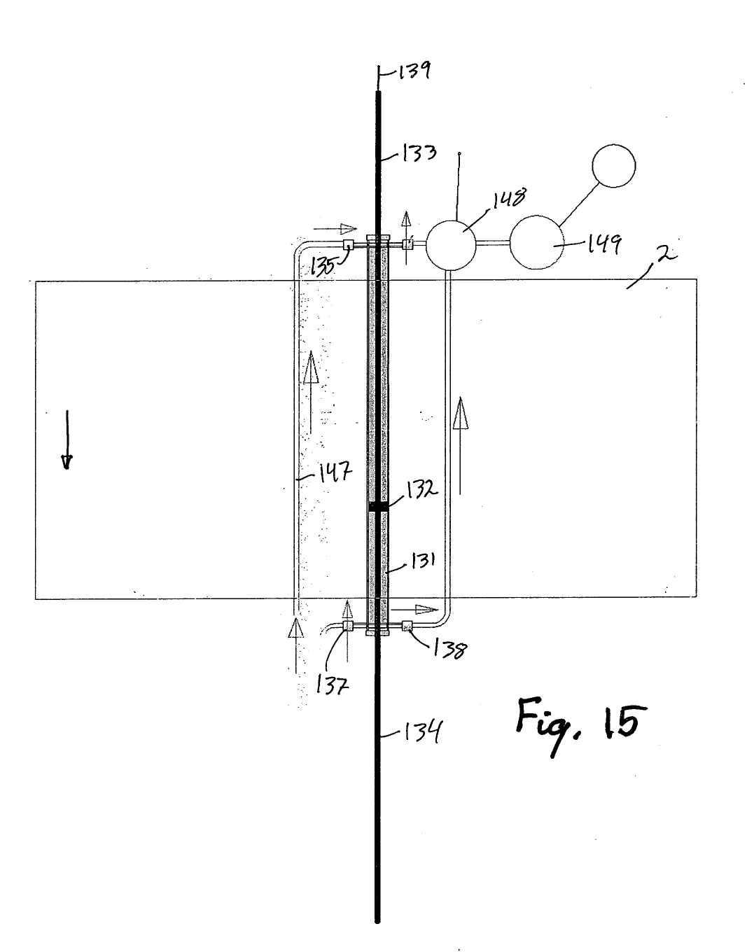

FIG. 15 shows the working mode of the hydraulic energy generation system when the floating body moves upwards, and

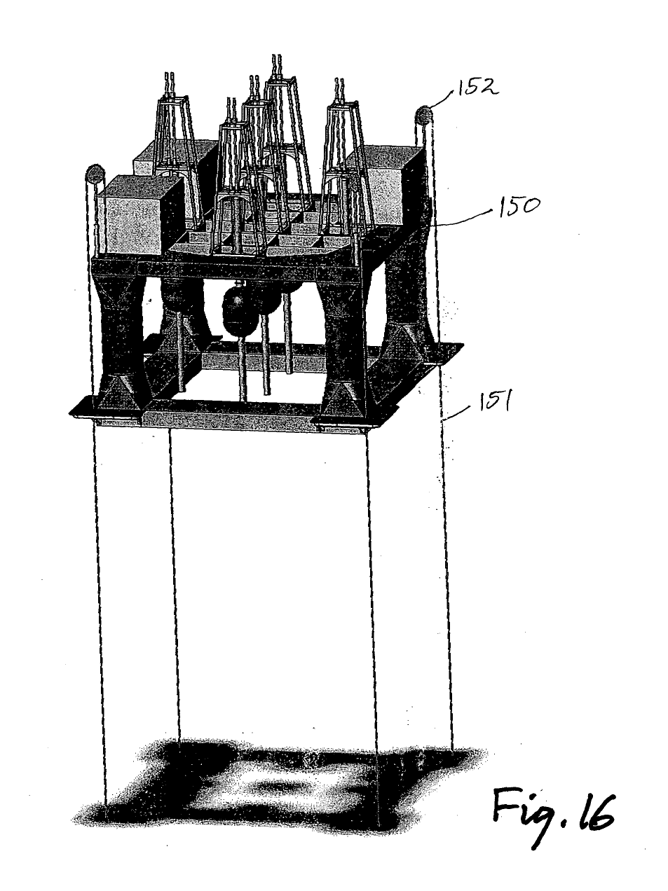

FIG. 16 shows a platform with several floating bodies that are anchored via tension legs.

FIG. 1 shows a device for generation of wave energy according to the present invention. It comprises a central, floating body 1 which is in the form of a long cylinder and is preferably manufactured from aplastic pipe, for example, of polyethylene, or a composite pipe with reinforced fibres in a plastic matrix. A ring-formed floating body 2 is arranged around the central body and functions as a wave energy generation element. The ring-formed body 2 can be manufactured from the same material as the central body and is mounted in the central body 1 so that it can glide, for example, via gliding shoes or, as shown, via rollers 3. A number of rods 4, 5, for example, two rods as shown, are secured to the ring-formed body 2 and extend to a respective wheel 6 (only the one is shown) which is connected via a shaft 7 to a generator 8 on the central body. The rods 4, 5 are preferably, as shown, led through respective ears 9 on the central body 1, to ensure that the rods 4, 5 move axially only. The rods 4, 5 are preferably toothed rods and the wheel 6 is preferably a corresponding cogwheel.

To prevent the ring-formed body 2 from rotating in relation to the central body 1, guiding rods 10, 11 can be arranged that stretch between the respective brackets 12, 13 on the central body 1.

The central body 1 is fitted with an anchorage element 14 in the form of a fork which is collected in an anchorage ring 15. A tension leg extends from the ring 15 to the ocean bed. To provide the right tension in the tension leg, a jigger winch can be arranged at a suitable location on the central body 1. A jigger winch comprises a hydraulic cylinder with one or more wire discs arranged on the piston rod and, at the opposite end, where the wire is placed one or several times over the discs such that one can take in and give out wire by actuating the cylinder. Thus, one can compensate for large tidal differences. If the tidal differences are relatively moderate, it can be sufficient to adapt the travel distance of the ring-formed body 2 such that the movements with the waves for the ring-formed body 2, independent of the tide, will always lie within the area between the brackets 12, 13. The ring-formed body 2 will thereby move in the upper part of this area at high tide and the lower part of this area at low tide, while the central body 1 will always lie at the same distance to the ocean bed.

The central body 1 is best shown in FIG. 2. It comprises a pipe 17, where a number of decks 18, 19, 20, 21, 22 and 23 are arranged, which divide the inside of the pipe 17 into a number of chambers. To give access to the chambers, most of them are fitted with a manhole 24, 25, 26 and 27. The lower chamber 28 is open from below so that water can come in. The next chamber from below 29 is open at the manhole 24 only. However, this manhole 24 can be sealed by a watertight lid (not shown), so that the chamber 29 is watertight and can function as a trimming tank. The next chamber 30 can also be sealed with the help of a watertight lid in front of the waterhole 25, so that this can also function as a trimming tank. The chamber 31 is a further buoyancy chamber.

The chamber 32 is set up to contain packs of batteries 34 (see FIG. 1) for the operation of equipment onboard the device. The chamber 33 is set up to hold the generator 8. Both these chambers can be sealed with the help of doors (not shown) in front ofthe manholes. The waterline will lie between the decks 20 and 21, such that the chambers 32 and 33 will normally lie above the waterline all the time.

To achieve a good operation of the wave power installation and the best possible efficiency, it is important that the central body is anchored under tension in relation to the ocean bottom. The tensile force which is exerted due to the buoyancy ofthe central body should at any time lie at, at least, the same value as the weight of the power installation, i.e. that if the power installation weighs 2.5 tonnes, the tension in the tension leg 16 should be at least 2.5 tonnes. However, it is preferred that the tension is twice the weight of the power installation, which in this case means about 5 tonnes. With a tension of the order of the same or more than the weight, the central body will move very little in relation to the ocean bottom. The vertical movement will be of the order of a few centimetres and happen only because of a certain elasticity in the tension leg 16. The horizontal movement will be of the order of 1 meter. Such a limited movement will not cause noticeable lopsided positions and the central body can be said to lie vertically at all times.

It is also decisive for the stability of the central body that there is a ballast chamber below the ocean surface. It is preferred that all water ballast is placed below the ocean surface at all times. This will give the central body very good stability and together with the high tension in the tension leg will ensure that the central body is kept vertical even when it is influenced by waves, currents and wind.

If there are greater tide differences in the area than what can be taken up by the permitted travelling distance of the ring-formed body 2, one will be able to lift and lower the central body 1 in relation to the ocean bottom with the help of the jigger winch or other appliances that can give out and take in the tension leg. This regulation can take place automatically in that the average water level is measured and the depth position of the central body 1 is adjusted so that the average water level lies approximately about in the middle of the permitted travelling distance of the ring-formed body 2. The regulation can also take place in regard to tide tables which are inserted into a computer at the power installation. However, during this adjustment, a minimum tension is maintained in the tension leg corresponding to at least the weight of the power installation on a dry basis.

The ring-formed body shall now be explained in more detail with reference to the FIGS. 3 and 4. FIG. 3 shows a vertical section through the ring-formed body and FIG. 4 shows a horizontal section through the ring-formed body 2. Vertically and horizontally are used here to describe the user position ofthe individual components.

The ring-formed body 2 is composed of pipe sections 40 ofthe same diameter. The pipe sections 40 are cut at an angle of 45° at each end 41, 42. 45° is 360° divided by the number of pipe sections which, in the example shown, is eight. Then the pipe sections 40m are welded together so that they form an octagon. In this connection an octagon is an approximate circle and for all practical purposes the ring-formed body 2 will behave as if it were circular. However, it is also conceivable to put together the ring-formed body 2 from more or fewer sections than eight. One can even imagine, especially for a smaller power station, to use a triangular body instead of an approximate ring-formed body. As the pipe sections are cut at the same angle at each end, the pipe that serves as a template is placed in a cutting machine and for each new cut the pipe can either be rotated 180° about its own axis or the cutting tool is rotated to the opposite, complementary angle for each cut. Thus, no pipe material will be wasted.

A series of brackets are welded onto the inner circumference of the ring-formed body 2. Four brackets 43 comprise horizontal ears, where two diametrically opposite brackets 43 are set up for the fastening of the rods 4, 5 which transmit the movement to the generators 8, and the other two brackets 43 are set up to encircle the guiding rods 10, 11. The other brackets 44 will be fitted with rollers 3, as shown in FIG. 1.

Alternatively, the brackets 44 can be somewhat extended in towards the centre of the ring-formed body 2 and, in itself, form gliding surfaces towards the central body 1, possibly towards glide rails (not shown) arranged on the central body.

Instead of the guiding rods 10, 11 being led through holes in the brackets 43, they can also lie between two respective brackets so that the ring-formed body 2 is prevented from rotating. The guiding rods can in this case be replaced by rails that are fitted permanently, for example, welded onto the outer surface of the central body 1.

The ring-formed body 2 is preferably filled with air and is watertight. However, it is conceivable to ballast the ring-formed body 2, for example, with variable ballast, so that the specific frequency of the ring-formed body 2 can be adapted to the dominating frequency of the area.

FIG. 1 shows that the central body is fitted with a so-called LIDAR unit 35 (Light Detection and Ranging). In a special application of the wave energy generation unit according to the invention, the LIDAR unit is used to measure wind speeds in an ocean area where windmills are located. The wave energy generation unit can be placed in connection to a windmill part or one such unit can be arranged in connection with one single windmill. Wave energy generation units with LIDAR arepreferably arranged at different sides of the windmill or the windmill park, such that the speed of the incoming wind can be measured even if the wind direction changes. The converted wave energy can then be used to drive the LIDAR unit and associated equipment. In such a case the energy generation unit does not need to be larger than what is required to supply the LIDAR unit and associated equipment with electric power. The energy generation unit is also fitted with solar panels which function as additional power sources. These should have sufficient power to keep the batteries 34 adequately charged if periods with little wave activity should arise.

FIG. 5 shows an alternative embodiment of the energy generation unit according to the invention. This embodiment is most appropriate for large wave power installations which shall supply an offshore drilling or production unit of oil and/or gas or provide electrical power to households or industry on land.

The energy generation unit according to FIG. 5 comprises a central body 1 which in principle is formed as the central body 1 in FIG. 1, but has both a larger diameter and is longer. Around the central body lies a ring-formed body 2 which has a considerably larger diameter and height than the ring-formed body 2 in FIG. 1. It can be seen that the ring-formed body 2 is also larger in relation to the central body 1 than is the case in FIG. 1.

Four pillars 50 that cany a base 51 for a number of hydraulic cylinders 52 are arranged at the top ofthe central body 1. The hydraulic cylinders 52 are connected to the base 51 by the piston rods, while the cylinders themselves are set up in pockets 53 in the ring-formed body 2. The hydraulic cylinders can be based on oil hydraulics, water hydraulics (for example, sea water), or gas hydraulics (for example, air).

The ring-formed body 2 is run on a number (for example, three as shown) of rails 54 that prevent the ring-formed body 2 from rotating about the central body 1. In addition, axial sleeve bearings 55 can be arranged on the outer surface of the central body 1.

The energy generation unit is fitted with a jigger winch 56 connected to the tension leg 16. This has the same function as the jigger winch described above.

Instead of, or in addition to, the jigger winch 16, the pillars 50 can be telescopic so that the travelling distance of the ring-formed body 2 can be adjusted in relation to the central body 1, in this way one can also take tidal differences into consideration, such that, for example, at low tide the base 51 is lowered so that the ring-formed body 2 travels over a lower-lying part of the central body 1, but, in the main, over the same distance in relation to the water surface.

For any transmission of power to an offshore installation or ashore, a power cable is led in a separate channel through the central body, along the tension leg down to the ocean bottom and further along the ocean bottom to the installation or ashore.

The energy transmission appliances can be of any suitable type, also electrical transmission by, for example, axial generators.

Instead of the toothed rods, hydraulic cylinders can be used. These can, for example, be sea water cylinders which, in addition to driving a turbine, can be set up to pump sea water to an installation for reverse osmosis in the central body, as shown in the FIGS. 6a and 6b. Shown here is a section of the ring-formed body 2 and one can see one of the cylinders 53 with its piston rod 52. When the body 2 moves downwards, as shown in FIG. 6a, the piston 52a will pump sea water into the cylinder 53 through a non-return valve 57. When the body 2 moves downwards, as shown in FIG. 6b, the valve 57 will shut and the water is forced by thepiston 52a up a channel 58. This channel also has a non-return valve 59 which prevents the water from running back into the cylinder 53. The channel 58 leads to a tank 60 for reverse osmosis. The pressure which is thereby built up in the tank 60 will produce fresh water which can be taken out either directly or via a turbine 61. The principle for reverse osmosis is well known and will not be explained in any detail here. Such a system will be well suited to area where there is a need for both electricity and fresh water.

It is an advantage that there is more than one toothed rod or cylinder arranged symmetrically around the central body so that the load on the ring-formed body is evenly distributed. It is both conceivable that the cylinder is anchored to the central body and the piston rod of the cylinder is anchored to the ring-formed body and that the cylinder is anchored in the ring-formed body and the piston rod is anchored to the central body. However, the latter is preferred.

An alternative, but presently preferred embodiment of the wave energy generation device, where chains 100 are used to transmit the forces from the ring-formed body 2 to the cogwheels 6 instead of toothed rods, is shown in FIG. 7. Preferably two chains 100 are used, which are placed diametrically opposite of each other on each side of the central body 1. Only one of these chains 100 is shown in FIG. 7. The chains 100 are led across a respective turning wheel 101 at the lower bracket 12. The one rotation 102 of the chain 100 is fastened to the ring-formed body 2, while the other rotation 103 travels freely on the inside of the ring-formed body 2.

Also shown in FIG. 7 is a number (in this case four) of shock absorbers 104 which are set up to push against the underside of a platform 105 if the ring-formed body 2 should get a large upwards movement as a consequence of large wave movements. If the sea is very rough, something which can damage the wave generation device, the central body 1 can be lowered until the platform 105 lies against the shock absorbers 104 and the central body 1 and the ring-formed body 2 can lie to float together without mutual movements until the storm is over.

It has been shown that the heat expansion of the central body 1 is so large that the chain 100 is subjected to very large forces when the central body is heated up by the sun. If this is taken into consideration by placing the chain 100 loosely over the turning wheel 101 and the cogwheel 6, the rotations 103 and 104 will hit against the central body 1 and other parts of the construction and there is a risk of the chain coming off the turning wheel 101 and the cogwheel 6. Therefore, there is a need for a compensation appliance which can compensate for the heat expansion.

The FIGS. 8-9 show three embodiment examples of such a compensating appliance.

FIG. 8 shows a first purely mechanical embodiment of a compensating appliance 106. This appliance 106 can be placed on the one rotation 102 of the chain between the chain 100 and the ring-formed body 2 on the inside of the ring-formed body 2. The appliance 106 comprises a rod 107 which is fastened at its one end to the chain 100 and has a plate 108 at its other end. The rod 107 extends through, and is axially moveable in, a hole in a housing 109. The housing is fastened to the ring-formed body 2 via an adjustable threaded bolt 110. A compression spring 111 is arranged between the plate 108 and the housing 109. When the chain 100 is fitted, the compression spring 111 comes under tension so that it keeps the chain 100 taut when the temperature sinks to its lowest user temperature. When the temperature increases towards the highest user temperature, the compression spring 111 is compressed further and thereby takes up the heat extension of the central body 1. Thus, the tension in the chain 100 is kept within acceptable values.

FIG. 9 shows an alternative, mechanical chain tightener 106. It is set up to be placed between the rotations 102, 103 of the chain 100. It comprises a pair ofpressure elements 112, 113, which are secured to the central body 1. Each of the pressure elements 112, 113 is connected via a pair of piston rods 118, 119 to a gliding block 114, 115 which acts against the chain 100 and is set up to force apart of the chain 100 against an element 116, 117. As the gliding block 114, 115 and the elements 116, 117 have complementary contact surfaces, the section of the chain 100 which lies between these will be forced to make a loop shape. If the tension in the chain is increased, the chain 100 will force the gliding blocks towards each other and the loop is smaller. The heat extension of the central body 1 is thereby taken up.

FIG. 10 shows a preferred hydraulic embodiment of the compensating appliance 106. It comprises a hydraulic or pneumatic cylinder 120 to which a piston 121 with a piston rod 122 is arranged. The cylinder 120 is secured to the ring-formed body 2 and the piston rod is fastened to the chain 100 via an adjustable threaded casing 123. A compression spring 125 is arranged on the rod side 124, which gives a relatively low tension in the chain 100. The rod side 124 of the cylinder 120 is, via a cable 129, in communication with the piston side 127 of the cylinder 120 via an adjustable throttling 128 and the cable 129 is in communication with an accumulator 126.

When the tension in the chain 100 increases due to heat extension of the central body 1, the piston 121 is pulled towards the rod side 124. Then hydraulic fluid flows out of the rod side 124 and via the cable 129 and the throttling 128 to the piston side 127. As the spring 125 is relatively weak, the tension in the chain will not increase significantly because of the compression of the spring 125. The tension in the chain will therefore be approximately constant. When it gets colder and the central body becomes shorter again, the chain will slacken and the compression spring 125 will force the piston back in the cylinder 120 while the tension in the chain will be held approximately constant. Hydraulic fluid will then flow back to the rod side 124 via the throttling 128. The accumulator 126 ensures that there will be a small overpressure inside the cylinder.

FIG. 11 shows a further alternative embodiment of the invention. As for the preceding embodiments, the wave power installation comprises a central floating body 1 and a ring-formed floating body 2. Here, the central body is also connected to the ocean bed via at least one (not shown) tension leg. In this embodiment the central body has an expanded ballast chamber 130 at its lower end.

A number (in the case shown there are four) of double-acting hydraulic cylinders 131 are connected to the ring-formed body 2. A double-acting piston 132 is arranged in each of these, which is best shown in FIG. 12. An upper piston rod 132 and a lower piston rod 134 are connected to the piston 132. The double-acting cylinder has two gates 135, 136, 137, 138 at each end. The one gate is an inlet gate for sea water and the other is an outlet gate that leads to a pressure accumulator (not shown). A non-return valve is arranged in connection with each gate 135, 136, 137, 138, so that sea water can only flow in through the inlet gate and out through the outlet gate.

The piston rods 133, 134 are connected to a wire 139 that extends over an upper pulley system 140 and a lower pulley system 141 so that the wire ties together the outer ends of the pistons rods 133, 134 with each other. The upper and the lower pulley systems 140, 141 are, in principle, the same and only the upper 140 shall therefore be explained in detail with the help of FIG. 13. The pulley system 140 comprises two pulleys 142, 143 for each wire 139. The were 139 is led across the pulleys 142, 143 so that the wire 139 is turned 180° . At least one ofthe pulleys 142, 143 can move so that changes in the length of the wire 139 or in the distance between the pulley systems 140, 141 due to heat expansion or tension can be compensated for. At least one of the pulleys is fitted with a brake so that the wire does not move in relation to the pulleys 142, 143 unless the forces that the wire are subjected to exceed a predetermined value. One or both the pulleys 142, 143 can also be fitted with a drive device such that the wire can be made to move across the pulleys when required.

The lower pulley system 141 can be of a simpler type than the upper pulley system 140 and not comprise a brake or a drive device.

FIG. 14 shows a plain principle diagram of the hydraulic energy output system for the wave power installation in FIG. 11. The cylinder 131 stretches through a channel 144 in the ring-formed body 2 and is fastened to this with the help of suitable fastening means 145. The cylinder can flip about the fastening means 145, and a spring and dampening system 146 takes up the forces from the flipping movement. Thus, fatigue because of side forces on the cylinder 131 is avoided.

The inlet gate 135 at the upper end of the cylinder 131 is connected to a pipe 147 that runs through the floating body 2 and down to its underside. Here, the pipe 147 is open to the sea water. The outlet gate 136 at the upper end of the cylinder 131 is connected to a hydraulic accumulator 148. This is in turn connected to a unit 149 for reverse osmosis.

The inlet gate 131 at the lower end of the cylinder 131 is open to the sea water. The outlet gate 138 is, for its part, also connected to the accumulator 148.

The piston rods 133, 134 ofthe cylinder 131 are, as mentioned above, connected to the wire 139. The wire is held fast with the help of a brake on at least one of the pulleys 142, 143 in the upper pulley system 140. Thereby, the cylinder 131 will move in relation to the piston 132 when the floating body 2 moves up or down as a consequence of wave movement.

When the floating body 2 moves upwards, thepiston 132 moves downwards in the cylinder 131. Sea water will thereby be sucked into the topside of thepiston 132. At the same time, sea water will be forced out of the cylinder through the lower outlet 138 and further to the pressure accumulator 148. Conversely, sea water will be sucked in at the underside of the piston 132 and sea water will be forced out from the top of the piston 132 when the floating body 2 moves downwards. Sea water will thereby be pumped into the accumulator 148. This sea water will continuously be transferred to the unit 149 for reverse osmosis, where the sea water will be split into fresh water and salt water. The fresh water can be brought ashore, while the salt water can be let into the sea again.

Alternatively, the pressurized sea water in the accumulator 146 can, of course, be used to drive a turbine for production of electric energy. In this case, one can use hydraulic oil in a closed system instead of sea water, or possibly air.

The brake on at least one pulley can be set so that if the piston 132 reaches the end of the cylinder before the wave movement in the same direction has been completed, the forces in the wire 139 will exceed the braking power of the brake. The pulleys 142, 143 will thereby rotate and the wire will move over them. In this way, the piston 139 will move in the wave direction. Movements with the tide will be compensated for in that the piston moves with the tide as the tide level changes. Large waves that exceed the travel of the piston inside the cylinder can also be taken up in this way.

Instead of the cylinder 131 forcing the piston 132 upwards or downwards, sensors can also be arranged on the cylinder which detect the position of the piston 132 and drive the pulleys 142, 143 to move the piston.

If the accumulator 148 reaches its maximum pressure, for example, because more pressure is produced than the unit 149 for reverse osmosis can receive, an automatic valve can be connected up to short-circuit between the inlet gate on the one side of the piston and the outlet gate on the other side such that the sea water is only brought from the one side of the piston to the other side without further pressure being accumulated. A valve from the outlet gate to the sea can also be opened so that the water simply is led out into the sea again.

FIG. 15 shows a platform 150 of the type which is described in WO 2004/113718, which is hereby incorporated by reference. Contrary to the wave power installation which is described in the abovementioned publication, the platform 150 in the wave power installation in FIG. 15 is anchored to the ocean bottom with a tension leg 151 so that the platform is lying approximately steady vertically. To compensate for tidal changes, the platform 150 is fitted with one jigger winch for each tension leg. These are connected to a sensor for the tide level (for example, a laser that measures the average distance from the deck of the platform to the ocean surface) which ensures the adjustments of the jigger winch according to the changes in the tide level.

1. A device for generation of wave power comprising:
a first floating body adapted to float in a body of water and anchored to a sea bed;
a second floating body, wherein the second floating body is adapted to move in relation to the first floating body under the influence of waves;
energy transmission means coupled between the first floating body and the second floating body to take up kinetic energy from the second floating body;
wherein the first floating body is anchored to a sea bed by a tension leg which is subjected to a sufficient tension so that the first floating body is not able to move vertically when influenced by waves; and
wherein the first floating body has at least one ballast chamber adapted to be located below the lowest level of a water surface of the body of water which the first floating body is floating in.

2. The device according to claim 1, wherein the tension in the tension leg is at least as great as a total weight of the device in a dry state.

3. The device according to claim 1, wherein the second floating body has a travelling distance which is at least as large as a vertical distance between a trough of the waves at low tide and a wave top at high tide so that the second floating body can move over a whole wave period independent of a tide level.

4. The device according to claim 1, wherein the first floating body is equipped with a jigger winch which is adapted to adjust the tension in the tension leg.

5. The device according to claim 4, wherein the jigger winch is adapted to adjust a distance of the first floating body from the sea bed to adjust a depth-draught of the first floating body in relation to a tide level.

6. The device according to claim 5, wherein the first floating body is held in a position where the average water level is in a middle of a travel distance for the second floating body.

7. The device according to claim 1, wherein the first floating body is a central extended body which is adapted to float in a mainly vertical position and the second floating body encircles the first floating body.

8. The device according to claim 1, wherein the energy transmission means comprise rods that extend from the second floating body to a rotary organ on the first floating body.

9. The device Device according to claim 1, wherein ene-of the preceding claims, characterised in that the energy transmission means comprise at least one hydraulic cylinder.

10. The device according to claim 8, wherein the energy transmission means comprise at least two hydraulic cylinders which are placed so that the second floating body is symmetrically loaded.

11. The device according to claim 9, wherein the at least one hydraulic cylinder comprises a sea water cylinder.

12. The device according to claim 10, wherein the at least one hydraulic cylinder is adapted to pump sea water to an installation for reverse osmosis.

13. The device according to claim 9, wherein the at least one hydraulic cylinder itself is connected to the second floating body and a cylinder piston rod is connected to the first floating body.

14. The device according to claim 9, wherein the at least one hydraulic cylinder is a double-acting cylinder and that the piston rod from each side of a piston of the cylinder is connected to an extended, flexible body that runs over turning wheels on the first floating body such that the piston, the piston rods and the extended, flexible body form a continuous loop.

15. The device according to claim 14, wherein the extended, flexible body is adapted to move over the turning wheels when the tide level changes such that the position of the pistons moves with the tide.

16. The device according to claim 7, wherein the device comprises prevention means adapted to prevent the second floating body from rotating about the first floating body.

17. The device according to claim 16, wherein the prevention means comprise longitudinal rods or rails on the first floating body and organs on the second floating body which are set up to glide along the rods or the rails.

18. The device according to claim 1, wherein the energy transmission means comprise at least one chain that runs between the first floating body and the second floating body.

19. The device according to claim 18, wherein the at least one chain is fitted with a compensation means to compensate for a heat extension of the first floating body.

20. The device according to claim 19, wherein the compensation means comprises a hydraulic or pneumatic cylinder where each end of the hydraulic or pneumatic cylinder communicates with each other via a throttling.

21. The device according to claim 19, wherein the compensation means comprises a compression spring which brings about a minimum tension in the at least one chain but limits a maximum tension.
